(19) United States
(12) Patent Application Publication
(10) Pub. No.: US 2026/0149056 A1
(43) Pub. Date: May 28, 2026

(54) SECONDARY BATTERY

(71) Applicant: SK On Co., Ltd., Seoul (KR)

(72) Inventor: Na Hyeon KIM, Daejeon (KR)

(21) Appl. No.: 19/386,225

(22) Filed: Nov. 12, 2025

(30) Foreign Application Priority Data
Nov. 27, 2024 (KR) 10-2024-0172015

(51) Int. Cl. H01M 10/42; H01M 50/103

(52) U.S. Cl. CPC H01M 10/4235; H01M 50/103

(57) ABSTRACT

Disclosed is a secondary battery. According to the present disclosure, the secondary battery includes a case, an electrode assembly disposed inside the case, a porous sheet disposed between the case and the electrode assembly and configured to temporarily accommodate an electrolyte inside the case or discharge the accommodated electrolyte, and a diffusion guide disposed on the porous sheet and configured to guide the electrolyte discharged from the porous sheet to flow inside the case.

### CROSS-REFERENCE TO RELATED APPLICATION

The present application claims priority to and the benefit of Korean Patent Application No. 10-2024-0172015, filed on Nov. 27, 2024 in the Korean Intellectual Property Office, the entire disclosure of which is incorporated herein by reference.

### BACKGROUND

### 1. Field of the Invention

Embodiments of the present disclosure relate a secondary battery.

### 2. Discussion of Related Art

A secondary battery is one type of energy storage means that can be charged and discharged through an electrochemical reaction. The secondary battery is used in various fields using electrical energy. For example, the secondary battery is widely used in the field of mobile devices such as mobile phones, notebooks, and tablets, and broader use is being sought in the field of transportation equipment such as vehicles, aircraft, and ships. In addition, demand for secondary batteries is increasing in the field of energy storage systems (ESSs) for utilizing surplus power.

Some of the secondary batteries use an electrolyte as a medium for the movement of lithium ions. In such secondary batteries, the amount of electrolyte may affect the performance, lifetime, and manufacturing cost of the secondary battery. For example, an excessive amount of electrolyte may have unfavorable effects in terms of side reactions or process costs, and conversely, an insufficient amount of electrolyte may have unfavorable effects in terms of performance. Accordingly, more effective management of the electrolyte is required.

### SUMMARY OF THE INVENTION

Some embodiments of the present disclosure are directed to providing a secondary battery.

Some embodiments of the present disclosure are also directed to providing a secondary battery capable of more uniformly distributing an electrolyte.

Some embodiments of the present disclosure are also directed to providing a secondary battery capable of alleviating electrolyte depletion according to an arrangement direction.

Some embodiments of the present disclosure are also directed to providing a secondary battery capable of autonomously implementing an electrolyte distribution function.

Some embodiments of the present disclosure are also directed to providing a secondary battery in which performance or lifetime may be improved.

Some embodiments of the present disclosure may be widely applied in green technology fields such as electric vehicles, battery charging stations, and solar power generation and wind power generation utilizing batteries. In addition, some embodiments of the present disclosure may be used in eco-friendly electric vehicles, hybrid vehicles, and the like to prevent climate change by suppressing air pollution and greenhouse gas emissions.

According to an aspect of the present disclosure, there is provided a secondary battery including a case, an electrode assembly accommodated inside the case, a porous sheet disposed between the case and the electrode assembly and configured to temporarily accommodate an electrolyte inside the case or discharge the accommodated electrolyte, and a diffusion guide disposed on the porous sheet and configured to guide the electrolyte discharged from the porous sheet to flow inside the case.

In some embodiments, the case may be provided as a prismatic case having a predetermined level of rigidity.

In some embodiments, the electrode assembly may be provided to expand and contract in a thickness direction according to charging and discharging.

In some embodiments, the porous sheet may be provided with pores in which the electrolyte is accommodated.

In some embodiments, the porous sheet may be elastically deformed according to expansion and contraction of the electrode assembly and provided to be compressed and relaxed in a thickness direction.

In some embodiments, the electrode assembly may include a front surface and a rear surface spaced apart in a thickness direction, and the porous sheet may have an area corresponding to the front surface or the rear surface and may be provided to be in surface contact with the front surface or the rear surface.

In some embodiments, the electrode assembly may include a front surface and a rear surface spaced apart in a thickness direction, and the porous sheet may be disposed on each of the front surface and the rear surface.

In some embodiments, the porous sheet may be provided to be compressed between the case and the electrode assembly as the electrode assembly expands, thereby discharging the accommodated electrolyte into the case.

In some embodiments, the porous sheet may be provided to be relaxed between the case and the electrode assembly as the electrode assembly contracts, thereby accommodating the remaining electrolyte inside the case.

In some embodiments, the diffusion guide may be provided to guide at least a portion of the electrolyte discharged from the porous sheet to flow to an upper region of the electrode assembly.

In some embodiments, the diffusion guide may include a first guide rod provided to vertically extend on one surface of the electrode assembly, and a plurality of first guide rods may be provided to be spaced apart in a width direction on one surface of the electrode assembly.

In some embodiments, the diffusion guide may be provided to guide at least a portion of the electrolyte discharged from the porous sheet to flow to an edge region in a width direction of the electrode assembly.

In some embodiments, the diffusion guide may include a second guide rod provided to extend in a width direction on one surface of the electrode assembly, and a plurality of second guide rods may be provided to be spaced apart in a vertical direction on one surface of the electrode assembly.

In some embodiments, the porous sheet may have a thickness of a central region in a width direction that is smaller than a thickness of an edge region thereof.

In some embodiments, the diffusion guide may be provided to be embedded in the porous sheet.

In some embodiments, the secondary battery may further include another porous sheet disposed inside the electrode assembly and configured to temporarily accommodate the electrolyte inside the electrode assembly or discharge the accommodated electrolyte.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings, in which:

FIG. 1 is a partially cutaway perspective view illustrating a secondary battery according to one embodiment of the present disclosure;

FIG. 2 is an internal perspective view illustrating a state in which a case is removed in FIG. 1;

FIG. 3 is a transverse sectional view along line C1-C1′ illustrated in FIG. 2;

FIG. 4 is a longitudinal sectional view along line C2-C2′ illustrated in FIG. 2;

FIG. 5 is an internal perspective view illustrating a secondary battery according to another embodiment of the present disclosure;

FIG. 6 includes a partially cross-sectional view and a perspective view illustrating a secondary battery according to still another embodiment of the present disclosure;

FIG. 7 is a transverse sectional view illustrating a secondary battery according to yet another embodiment of the present disclosure;

FIG. 8 is a transverse sectional view illustrating a secondary battery according to yet another embodiment of the present disclosure; and

FIG. 9 is a transverse sectional view illustrating a secondary battery according to yet another embodiment of the present disclosure.

### DETAILED DESCRIPTION OF EXEMPLARY EMBODIMENTS

Hereinafter, the present disclosure will be described in detail with reference to the accompanying drawings. However, this is merely exemplary, and the present disclosure is not limited to the exemplified specific embodiments.

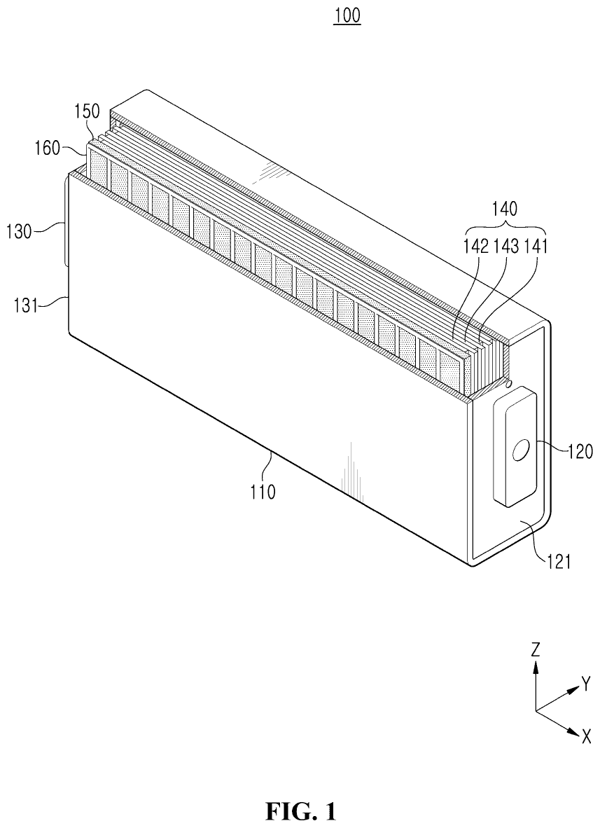

FIG. 1 is a partially cutaway perspective view illustrating a secondary battery according to one embodiment of the present disclosure.

For convenience, hereinafter, based on the coordinate axes shown in FIG. 1 and the like, an X-axis direction is referred to as a left-right direction or a width direction, a Y-axis direction is referred to as a front-rear direction or a thickness direction, and a Z-axis direction is referred to as an up-down direction or a height direction.

Referring to FIG. 1, in some embodiments, a secondary battery 100 may be provided. In the illustrated embodiment, the secondary battery 100 is exemplified as having a roughly rectangular parallelepiped shape with a longer width than height. Such a secondary battery 100 may be commonly referred to in the art as a prismatic battery, prismatic cell, or the like. However, a form factor of the secondary battery 100 in the embodiments of the present disclosure is not necessarily limited to the exemplified form. The embodiments of the present disclosure may be properly implemented or applied to secondary batteries having cylindrical shapes, pouch shapes, coin shapes, or other non-standard shapes within the scope of the technical idea described below.

In some embodiments, the secondary battery 100 may include a case 110. The case 110 may form the exterior of the secondary battery 100. In the illustrated embodiment, the case 110 is illustrated as having an approximately rectangular parallelepiped shape, as described above. The case 110 may have a predetermined internal space. The interior space may accommodate an electrode assembly 140 described below, and the like.

The case 110 may include at least one opening. Components inside the case 110 such as the electrode assembly 140 may be assembled into the case 110 through the opening. In the illustrated embodiment, the case 110 is provided with openings on the left and right sides, respectively. The openings may be appropriately closed by first and second cap plates 121 and 131, respectively, after the electrode assembly 140 and the like are inserted. However, the positions, numbers, and the like of the openings and cap plates may be appropriately modified as necessary and are not necessarily limited to those illustrated. For example, the case 110 may be provided with openings and cap plates at positions different from those illustrated, or may be provided with one opening and one cap plate.

In some embodiments, the case 110 may be provided as a prismatic case having a predetermined level of rigidity. For example, the case 110 may be provided to substantially maintain its shape against a physical external force during normal use. That is, the case 110 may be provided with a material having relatively high rigidity compared to flexible film packaging materials. However, this does not mean that deformation of the case 110 is completely eliminated. For example, the case 110 may be made of a metal sheet material such as stainless steel or an aluminum alloy to have a predetermined level of rigidity. In some embodiments, such a case 110 may be combined with a porous sheet 150 to be described below to contribute to implementing a proper electrolyte distribution.

Meanwhile, in some embodiments, the secondary battery 100 may include a first electrode terminal 120 and a second electrode terminal 130. In the illustrated embodiment, the first electrode terminal 120 is disposed on a first cap plate 121 on one side in the width direction, and the second electrode terminal 130 is disposed on a second cap plate 131 on the opposite side. However, the positions of the first and second electrode terminals 120 and 130 may be appropriately changed as necessary and are not necessarily limited to those illustrated. For example, the first and second electrode terminals 120 and 130 may be disposed together on the same side of the secondary battery 100. The first electrode terminal 120 may be provided as a positive electrode terminal or negative electrode terminal, and the second electrode terminal 130 may be provided as a negative electrode terminal or positive electrode terminal corresponding thereto. For convenience, in this description, it is assumed that the first electrode terminal 120 is a positive electrode terminal and the second electrode terminal 130 is a negative electrode terminal.

Meanwhile, in some embodiments, the secondary battery 100 may include the electrode assembly 140. The electrode assembly 140 may be accommodated inside the case 110. In some embodiments, the electrode assembly 140 may include a first electrode 141 and a second electrode 142 disposed with a separator 143 interposed therebetween. The first electrode 141 may be provided as a positive electrode or negative electrode, and the second electrode 142 may be provided as a negative electrode or positive electrode. For convenience, in this description, it is assumed that the first electrode 141 is a positive electrode corresponding to the first electrode terminal 120, and the second electrode 142 is a negative electrode corresponding to the second electrode terminal 130.

In some embodiments, the first electrode 141 may include a positive electrode current collector and a positive electrode mixture layer. For example, the positive electrode current collector may include aluminum, stainless steel, nickel, titanium, or alloys thereof. The positive electrode mixture layer may be provided on at least one surface of the positive electrode current collector. The positive electrode mixture layer may include a positive electrode active material, and the positive electrode active material may include a compound capable of reversibly intercalating and deintercalating lithium ions. For example, the positive electrode active material may include a lithium-nickel metal oxide, and in some cases, the lithium-nickel metal oxide may further include cobalt, manganese, or aluminum.

In some embodiments, the second electrode 142 may include a negative electrode current collector and a negative electrode mixture layer. For example, the negative electrode current collector may include copper, stainless steel, nickel, titanium, or alloys thereof. The negative electrode mixture layer may be provided on at least one surface of the negative electrode current collector. The negative electrode mixture layer may include a negative electrode active material, and the negative electrode active material may include a compound capable of reversibly inserting and deintercalating lithium ions. For example, the negative electrode active material may include carbon-based materials such as crystalline carbon, amorphous carbon, carbon composites, or carbon fibers. Alternatively, the negative electrode active material may include lithium metal, lithium alloys, silicon-containing materials, or tin-containing materials.

The separator 143 may be provided between the first electrode 141 and the second electrode 142. The separator 143 may be provided to limit electrical short circuits between the first electrode 141 and the second electrode 142 and to allow ions to flow. In some embodiments, the separator 143 may include a porous polymer film, a porous nonwoven fabric, or the like. For example, the porous polymer film may include a polyolefin-based polymer such as an ethylene polymer, a propylene polymer, an ethylene/butene copolymer, an ethylene/hexene copolymer, or an ethylene/methacrylate copolymer. In addition, the porous nonwoven fabric may include high-melting-point glass fibers or polyethylene terephthalate (PET) fibers.

Meanwhile, in some embodiments, the secondary battery 100 may include the electrolyte. The electrolyte may be accommodated inside the case 110 together with the electrode assembly 140. In some embodiments, the electrolyte may be provided as a non-aqueous electrolyte including a lithium salt and an organic solvent.

In some embodiments, the amount of electrolyte impregnated in the electrode assembly 140 may affect the performance, lifetime, manufacturing cost, or the like of the secondary battery. For example, when the amount of electrolyte is excessive, various side reactions may be triggered depending on the composition of the electrolyte, thereby increasing the cost of the process. Conversely, when the amount of electrolyte is insufficient, there is less of a medium for the movement of lithium ions, and the performance of the secondary battery may decrease. In detail, initial electrolyte depletion can begin with the formation of a solid electrolyte interphase (SEI) layer on the surface of the electrode due to the decomposition of lithium salts in the electrolyte. Thereafter, with repeated expansion and contraction of the electrode during charging and discharging, a new interface is exposed, and as a new SEI layer is formed on the new interface, the amount of electrolyte may gradually decrease.

The above-described excess or insufficient electrolyte may be partially caused depending on each region of the electrode assembly 140. For example, in some regions, the electrolyte may be excessively distributed, whereas in other regions, the electrolyte may be insufficiently distributed. This may eventually be caused by an uneven distribution of the electrolyte. For example, the electrolyte may be distributed relatively biased toward a lower region of the electrode assembly 140 according to the arrangement direction of the secondary battery 100, which may cause excess electrolyte in the lower region of the electrode assembly 140 or insufficient electrolyte in an upper region of the electrode assembly 140.

In some embodiments, the above-described uneven distribution of the electrolyte may be appropriately alleviated through the technical configurations to be described below.

Meanwhile, in some embodiments, the electrode assembly 140 may be provided such that the first electrode 141, the separator 143, and the second electrode 142 are repeatedly disposed. In some embodiments, the electrode assembly 140 may be provided as a winding type, a stacking type, a z-folding type, or a stack-folding type including the first electrode 141, the separator 143, and the second electrode 142. In the illustrated embodiment, the electrode assembly 140 is exemplified as a sheet-shaped first electrode 141, separator 143, and second electrode 142 stacked in a thickness direction. However, the arrangement direction or the stacking form of the electrode assembly 140 may be variously modified as necessary, and is not necessarily limited to the illustrated example.

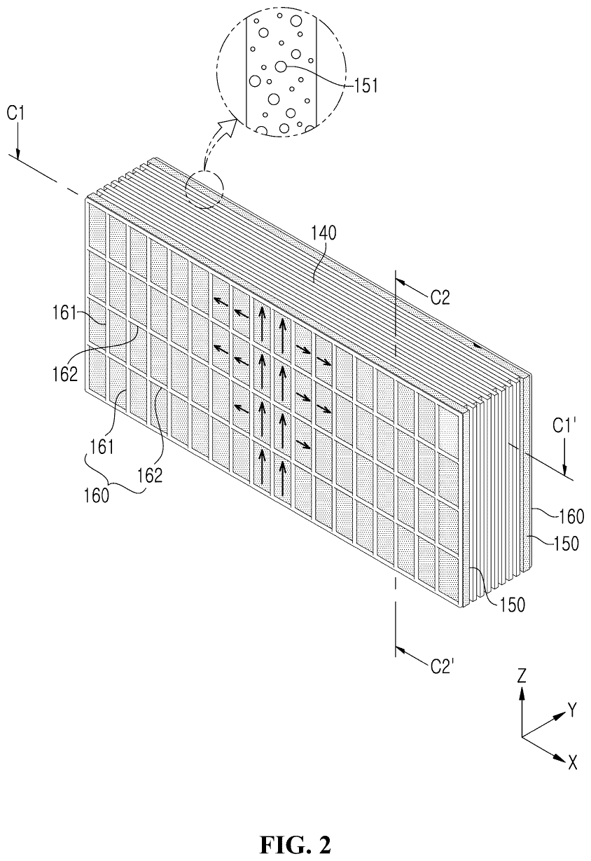

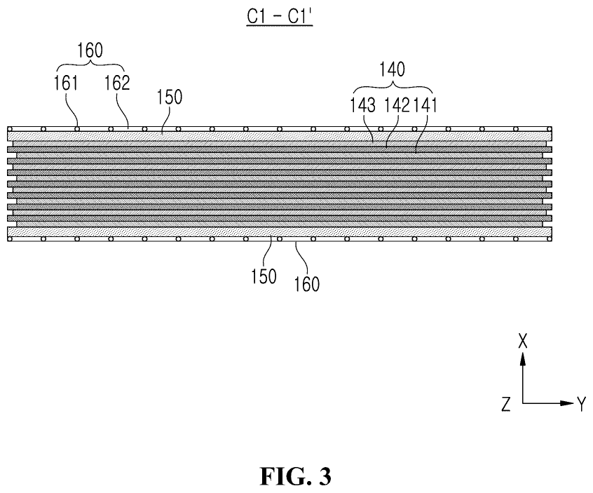

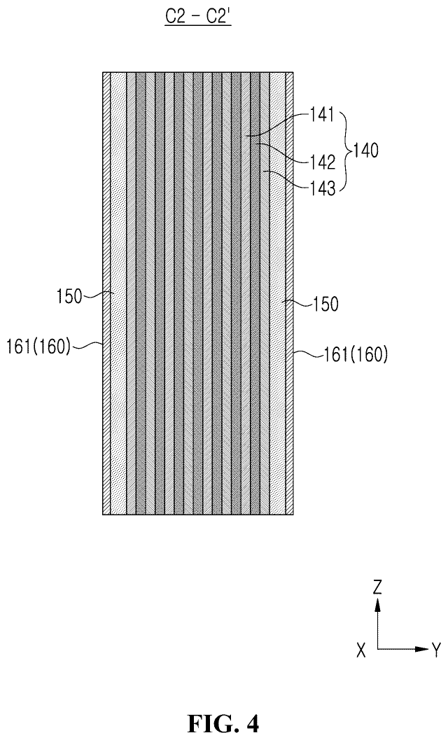

FIG. 2 is an internal perspective view illustrating a state in which a case is removed in FIG. 1. FIG. 3 is a transverse sectional view along line C1-C1′ illustrated in FIG. 2. FIG. 4 is a longitudinal sectional view along line C2-C2′ illustrated in FIG. 2.

Referring to FIGS. 2 to 4, in some embodiments, the secondary battery 100 may include the case 110, the electrode assembly 140 accommodated inside the case 110, the porous sheet 150 disposed between the case 110 and the electrode assembly 140 and configured to temporarily accommodate the electrolyte inside the case 110 or discharge the accommodated electrolyte, and a diffusion guide 160 disposed on the porous sheet 150 and configured to guide the electrolyte discharged from the porous sheet 150 to flow inside the case 110.

Specifically, in some embodiments, the secondary battery 100 may include the case 110. In some embodiments, the case 110 may be provided as a prismatic case having a predetermined level of rigidity as described above.

Meanwhile, in some embodiments, the secondary battery 100 may include the electrode assembly 140. The electrode assembly 140 may be accommodated inside the case 110.

In some embodiments, the electrode assembly 140 may be provided to expand and contract in a thickness direction according to charging and discharging. That is, the electrode assembly 140 may be provided to physically expand and contract according to intercalation and deintercalation of lithium ions. Such expansion and contraction may function to change the thickness of the electrode assembly 140. That is, the electrode assembly 140 may be provided such that the thickness thereof relatively increases during charging and relatively decreases during discharging. In some embodiments, the electrode assembly 140 may be provided to expand to a thickness substantially equal to an inner diameter of the case 110 when fully charged.

Meanwhile, in some embodiments, the secondary battery 100 may include the porous sheet 150. The porous sheet 150 may be disposed between an inner surface of the case 110 and an outer surface of the electrode assembly 140. In addition, the porous sheet 150 may be provided to accommodate the electrolyte or discharge the accommodated electrolyte. That is, the porous sheet 150 may be provided to absorb the electrolyte inside the case 110 to temporarily store the electrolyte, or discharge the stored electrolyte back into the inside of the case 110 by a predetermined operating force. In some embodiments, the porous sheet 150 may function to induce a uniform distribution of the electrolyte inside the case 110 through the accommodation and discharge of the electrolyte.

In some embodiments, the porous sheet 150 may include pores 151 for accommodating the electrolyte. The pores 151 may provide an accommodation space for the electrolyte. A plurality of pores 151 may be distributed inside and/or outside the porous sheet 150. For example, the porous sheet 150 may be provided as a sponge structure having a plurality of pores 151.

In some embodiments, the porous sheet 150 may have a predetermined porosity. For example, the porous sheet 150 may have a porosity of 40 to 65%. Alternatively, the porous sheet 150 may be provided to have the same or similar porosity as the separator provided in the electrode assembly 140. The porous sheet 150 may effectively perform discharge and accommodation of the electrolyte in response to the expansion and contraction of the electrode assembly 140.

In some embodiments, the porous sheet 150 may have at least a portion made of an elastic material. The porous sheet 150 made of an elastic material may be provided to be elastically deformed in response to the expansion and contraction of the electrode assembly 140. That is, the porous sheet 150 may be provided to be compressively deformed in the thickness direction between the electrode assembly 140 and the case 110 as the electrode assembly 140 expands. In addition, the porous sheet 150 may be provided to be elastically relaxed in the thickness direction as the electrode assembly 140 contracts.

In some embodiments, the porous sheet 150 may be made of a material having excellent chemical resistance to the electrolyte. For example, the porous sheet 150 may be partially or entirely made of polyurethane, silicone, ethylene propylene diene monomer (EPDM) rubber, or the like. However, the material of the porous sheet 150 is not necessarily limited to the materials exemplified.

In some embodiments, the porous sheet 150 may be disposed on a front surface and/or a rear surface of the electrode assembly 140. That is, the electrode assembly 140 may include the front surface and the rear surface spaced apart in the thickness direction, and the porous sheet 150 may be disposed on one or more of the front surface and the rear surface. In the illustrated embodiment, the porous sheet 150 is disposed on each of the front surface and the rear surface of the electrode assembly 140. The porous sheet 150 disposed on each of the front surface and the rear surface may contribute to more uniformly distributing the electrolyte by inducing the movement of the electrolyte at the front and rear of the electrode assembly 140.

In some embodiments, the porous sheet 150 may be provided in an extended form to cover both the front surface and the rear surface of the electrode assembly 140. For example, a portion of the porous sheet 150 may be disposed on the front surface of the electrode assembly 140, and another portion may extend from the portion above the electrode assembly 140 and may be disposed on the rear surface of the electrode assembly 140.

In some embodiments, the porous sheet 150 may be disposed on another surface other than the front surface and the rear surface of the electrode assembly 140. For example, the porous sheets 150 may be disposed on left and right side surfaces of the electrode assembly 140 or may be disposed on upper and lower surfaces thereof. The arrangement of the porous sheet 150 may be appropriately set in consideration of the location, direction, and magnitude of swelling occurring in the electrode assembly 140.

In some embodiments, the porous sheet 150 may be provided to have an area corresponding to the front surface and/or the rear surface of the electrode assembly 140. That is, the porous sheet 150 may be provided in a shape and size corresponding to the front surface and/or the rear surface of the electrode assembly 140. In addition, the porous sheet 150 may be provided to be in surface contact with the front surface or the rear surface of the electrode assembly 140. That is, the porous sheet 150 may be provided such that one surface thereof is in close contact with the entire front surface or rear surface of the electrode assembly 140. The porous sheet 150 in surface contact may enable a faster response to the expansion or contraction of the electrode assembly 140.

In some embodiments, the porous sheet 150 may be disposed between the electrode assembly 140 and the case 110. The porous sheet 150 may be disposed inside the case 110 in various ways as long as it is in a form capable of receiving an appropriate pressing force between the electrode assembly 140 and the case 110. For example, the porous sheet 150 may be disposed in a state of being in contact with and supported between the electrode assembly 140 and the case 110, or may be disposed in a state of being attached to one surface of the electrode assembly 140 or one surface of the case 110.

Meanwhile, in some embodiments, the porous sheet 150 may function to uniformly distribute the electrolyte to the entire region of the electrode assembly 140.

Specifically, the porous sheet 150 may function to absorb the electrolyte and accommodate the electrolyte in the pores 151. For example, when the electrode assembly 140 contracts during discharging, the porous sheet 150 may function to absorb the electrolyte remaining inside the case 110 while being elastically relaxed inside the case 110.

In addition, the porous sheet 150 may be provided to discharge the electrolyte accommodated in the pores 151 as the electrode assembly 140 expands. For example, when the electrode assembly 140 expands during charging, the porous sheet 150 may be elastically compressed between the case 110 and the electrode assembly 140, and accordingly, the electrolyte accommodated in the pores 151 may be discharged into the case 110.

The above-described absorption and discharge of the electrolyte by the porous sheet 150 may function to uniformly distribute the electrolyte to the entire region of the electrode assembly 140. That is, the electrolyte absorbed in the porous sheet 150 may be uniformly dispersed over the entire region of the porous sheet 150 by osmotic pressure, and as the dispersed electrolyte is discharged back into the case 110 through the porous sheet 150, the electrolyte may be uniformly distributed inside the case 110. In other words, the electrolyte may be uniformly distributed to the entire region of the electrode assembly 140, which may function to alleviate problems caused by the aforementioned uneven distribution of the electrolyte.

For example, the electrolyte may be distributed relatively biased to the lower region of the electrode assembly 140 during discharging according to the arrangement direction of the secondary battery 100. The porous sheet 150 may alleviate the uneven distribution of the electrolyte by absorbing the electrolyte concentrated in the lower region. In addition, the absorbed electrolyte may be uniformly dispersed inside the porous sheet 150 and then discharged to the outside of the porous sheet 150 as the electrode assembly 140 expands. In particular, in this process, the porous sheet 150 may also discharge the absorbed electrolyte to the upper region of the electrode assembly 140, thereby alleviating a phenomenon in which there is insufficient electrolyte in the upper region.

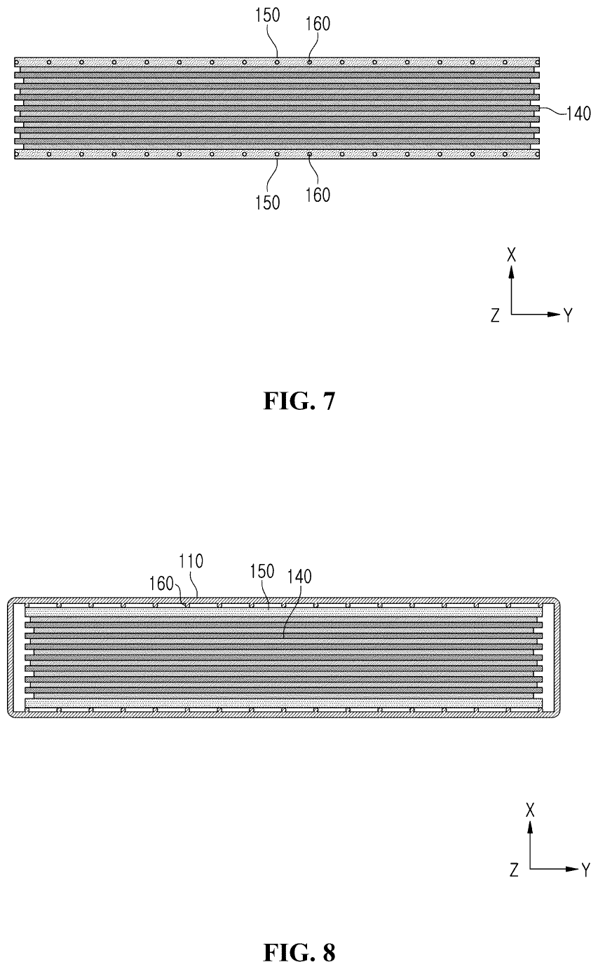

Meanwhile, in some embodiments, the secondary battery 100 may include the diffusion guide 160. The diffusion guide 160 may be disposed adjacent to the porous sheet 150. For example, the diffusion guide 160 may be disposed on one surface of the porous sheet 150 facing the electrode assembly 140, or may be disposed on a surface opposite to the one surface. Alternatively, the diffusion guide 160 may be disposed inside the porous sheet 150 as shown in FIG. 7 described below. In the illustrated embodiment, the diffusion guide 160 is exemplified as being disposed on one surface of the porous sheet 150 opposite to the electrode assembly 140.

In some embodiments, the diffusion guide 160 may be provided to guide the flow of electrolyte discharged from the porous sheet 150. That is, at least a portion of the electrolyte discharged from the porous sheet 150 may be guided to flow inside the case 110 while moving along the diffusion guide 160. In some embodiments, the diffusion guide 160 may be provided to guide at least a portion of the electrolyte to flow to the upper region of the electrode assembly 140. That is, the diffusion guide 160 may be provided to guide a portion of the electrolyte discharged from the porous sheet 150 to flow upward. As a result, a phenomenon in which there is insufficient electrolyte in the upper region as described above may be further alleviated.

In some embodiments, the diffusion guide 160 may implement the distribution of the electrolyte to the upper region through a first guide rod 161. The first guide rod 161 may be provided to vertically extend on one surface of the electrode assembly 140. In some embodiments, a plurality of first guide rods 161 may be provided, and the plurality of first guide rods 161 may be provided to be spaced apart in the width direction on one surface of the electrode assembly 140. Such first guide rods 161 may guide a portion of the electrolyte discharged from the lower region of the porous sheet 150 to flow to the upper region, thereby further alleviating an electrolyte imbalance between the upper and lower regions.

In some embodiments, the diffusion guide 160 may be provided to guide a portion of the electrolyte discharged from the porous sheet 150 to flow to an edge region in the width direction of the electrode assembly 140. As a result, both distribution of the electrolyte in the vertical direction and distribution of the electrolyte in the width direction may be achieved together. Accordingly, a more uniform distribution of the electrolyte over the entire region of the electrode assembly 140 may be achieved.

In some embodiments, the diffusion guide 160 may implement distribution of the electrolyte in the width direction through a second guide rod 162. The second guide rod 162 may be provided to extend in a left-right width direction on one surface of the electrode assembly 140. In some embodiments, a plurality of second guide rods 162 may be provided, and the plurality of second guide rods 162 may be provided to be spaced apart in the vertical direction on one surface of the electrode assembly 140. Such second guide rods 162 may guide a portion of the electrolyte discharged from a central region of the porous sheet 150 to flow to the edge region in the width direction, thereby further alleviating an electrolyte imbalance between the central region and the edge region.

In some embodiments, the diffusion guide 160 may be made of a material having excellent chemical resistance to the electrolyte. For example, the diffusion guide 160 may be partially or entirely made of polypropylene, polysulfone, polytetrafluoroethylene (PTFE), polyetheretherketone (PEEK), or the like. However, the material of the diffusion guide 160 is not necessarily limited to the exemplified materials.

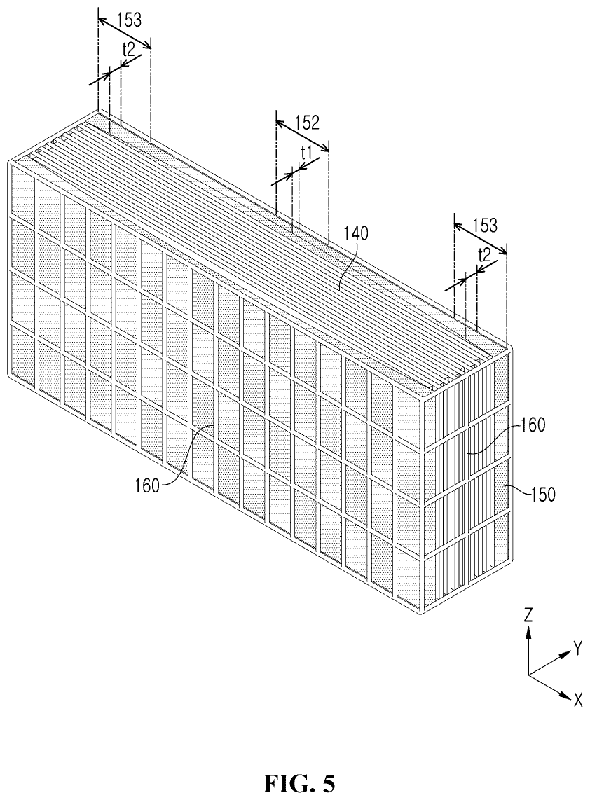

FIG. 5 is an internal perspective view illustrating a secondary battery according to another embodiment of the present disclosure.

For convenience, the following description will focus on differences from the above-described embodiment.

Referring to FIG. 5, in some embodiments, a thickness t1 of a central region 152 in the width direction of a porous sheet 150 may be formed smaller than a thickness t2 of an edge region 153. For example, the porous sheet 150 may be provided such that one surface facing an electrode assembly 140 is formed as a gently curved surface having a predetermined curvature, and thus the thickness t1 of the central region 152 may be formed smaller by a predetermined degree than the thickness t2 of both edge regions 153.

For reference, in the above, the central region 152 of the porous sheet 150 may refer to a region within a predetermined length range (for example, 10% of the entire width direction length) at the center in the width direction of the porous sheet 150, and the thickness t1 of the central region 152 may refer to an average thickness in the corresponding region. In addition, the edge region 153 of the porous sheet 150 may refer to a region within a predetermined length range (for example, 10% of the entire width direction length) from one end portion in the width direction of the porous sheet 150, and the thickness t2 of the edge region 153 may refer to an average thickness in the corresponding region.

The porous sheet 150 described above may function to appropriately press an edge portion of the electrode assembly 140 to alleviate a phenomenon in which the electrode is partially lifted at the edge portion. To elaborate, in the manufacturing process, the electrode undergoes a pressing process to increase the density of an active material applied to a current collector, and during the pressing, a difference in elongation ratio between the current collector and the active material may cause the edge portion to bend and lift. This lifting phenomenon may more typically occur at a portion where an electrode tab is disposed, and may also more typically occur in prismatic batteries. For example, although a pouch-type battery may alleviate the above-described lifting phenomenon to a significant extent through a press pre-charge (PPC) process in a formation operation, this is not the case for prismatic batteries due to the nature of their case. Accordingly, the porous sheet 150 described above may function to more effectively alleviate the above-described lifting phenomenon in prismatic batteries and the like.

Meanwhile, in some embodiments, diffusion guides 160 may also be provided on the left and right side surfaces in the width direction of the electrode assembly 140. That is, the diffusion guides 160 may be provided on a front surface and a rear surface of the electrode assembly 140 as in the above-described embodiment, and in addition, may be formed to extend to the left and right side surfaces of the electrode assembly 140. In some embodiments, the diffusion guide 160 may form a support that accommodates the porous sheet 150 and the electrode assembly 140 therein. That is, the porous sheet 150 and the electrode assembly 140 may be disposed in an inner region of the diffusion guide 160, and the peripheral surface may be appropriately supported through the diffusion guide 160. Accordingly, the porous sheet 150, the electrode assembly 140, and the diffusion guide 160 may be provided as one assembly, and such an assembly may be assembled and accommodated into the case, thereby providing a secondary battery.

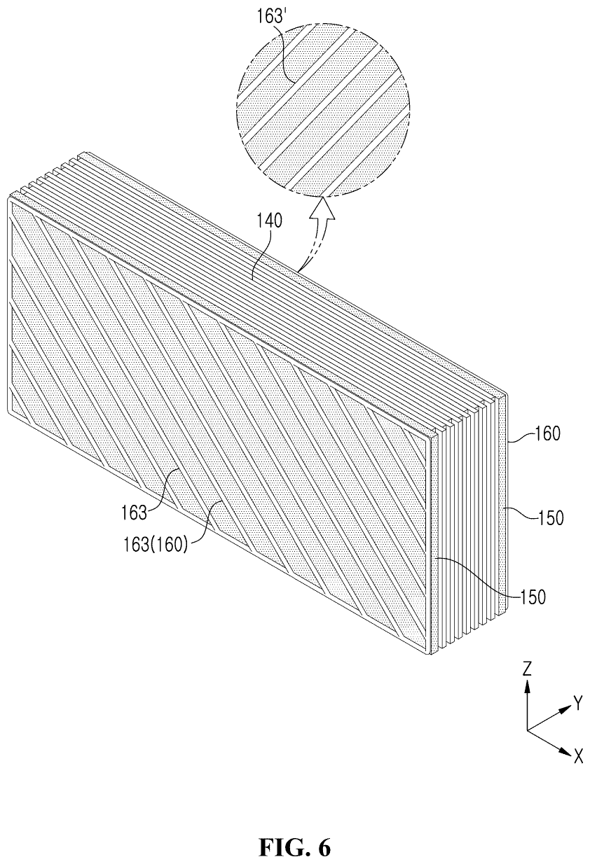

FIG. 6 includes a partial cross-sectional view and a perspective view illustrating a secondary battery according to still another embodiment of the present disclosure.

Referring to FIG. 6, in some embodiments, a diffusion guide 160 may include a third guide rod 163. The third guide rod 163 may be provided to extend obliquely on one surface of an electrode assembly 140. For example, the third guide rod 163 may extend obliquely at an angle of about 45 degrees with respect to the vertical direction. In some embodiments, a plurality of third guide rods 163 may be provided, and the plurality of third guide rods 163 may be provided to be spaced apart at predetermined intervals in a direction perpendicular to a longitudinal direction of the third guide rod 163.

The third guide rod 163 described above may function to guide a portion of the electrolyte discharged from a porous sheet 150 to flow obliquely. Accordingly, the electrolyte may be guided to flow in the width direction and the vertical direction of the electrode assembly 140 and distributed. That is, the functions of the first and second guide rods 161 and 162 described above may be integrated through the third guide rod 163.

In some embodiments, the third guide rod 163 may be provided on each of the front surface and the rear surface of the electrode assembly 140. Here, the third guide rod 163 disposed on the front surface of the electrode assembly 140 and a third guide rod 163′ disposed on the rear surface of the electrode assembly 140 may be disposed to be inclined in opposite directions. For example, the third guide rod 163 disposed on the front surface of the electrode assembly 140 may be provided to be inclined downward toward the right side as illustrated, and the third guide rod 163′ disposed on the rear surface of the electrode assembly 140 may be provided to be inclined downward toward the left side. This set of third guide rods 163 and 163′ inclined in the opposite directions may contribute to a more uniform distribution of the electrolyte.

FIG. 7 is a transverse sectional view illustrating a secondary battery according to yet another embodiment of the present disclosure.

Referring to FIG. 7, in some embodiments, a diffusion guide 160 may be embedded in a porous sheet 150. The diffusion guide 160 may function to guide the electrolyte discharged from pores 151 to flow inside the porous sheet 150. In some embodiments, an assembly of the diffusion guide 160 and the porous sheet 150 may be provided by foam-molding the porous sheet 150 on an outer side of the diffusion guide 160. The integrated diffusion guide 160 and porous sheet 150 may contribute to improving the assemblability of the secondary battery while implementing the electrolyte distribution function as described above.

FIG. 8 is a transverse sectional view illustrating a secondary battery according to yet another embodiment of the present disclosure.

Referring to FIG. 8, in some embodiments, a diffusion guide 160 may be provided on an inner surface of a case 110. That is, the diffusion guide 160 may be integrally provided on the case 110 to form a part of the case 110. For example, the diffusion guide 160 may be provided to protrude in a form of one or more of the first to third guide rods 161, 162, and 163 on the inner surface of the case 110 disposed to face a front surface and/or a rear surface of an electrode assembly 140. The diffusion guide 160 may contribute to simplifying a manufacturing process by omitting operations for assembling or disposing the diffusion guide 160.

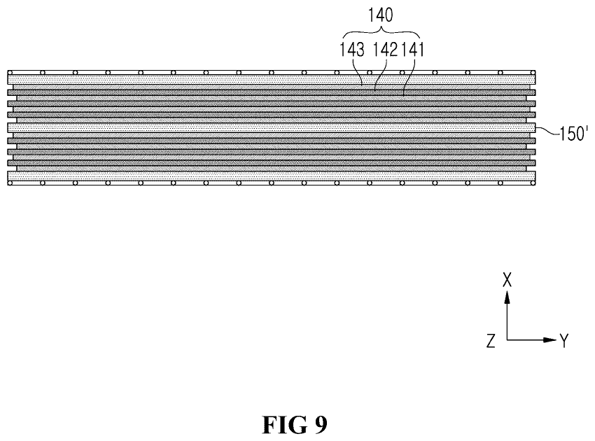

FIG. 9 is a transverse sectional view illustrating a secondary battery according to yet another embodiment of the present disclosure.

Referring to FIG. 9, in some embodiments, a porous sheet 150′ may be disposed inside an electrode assembly 140. For example, the porous sheet 150′ may be disposed between a first electrode 141 and a separator 143 inside the electrode assembly 140, or may be disposed between a second electrode 142 and the separator 143. The porous sheet 150′ may be provided to temporarily accommodate an electrolyte or discharge the accommodated electrolyte inside the electrode assembly 140, similar to the porous sheets of the above-described embodiments. That is, the porous sheet 150′ may be provided to absorb and discharge the electrolyte as the electrode assembly 140 contracts and expands. The porous sheet 150′ may contribute to further alleviating depletion of the electrolyte in an inner region of the electrode assembly 140.

In some embodiments, the porous sheet 150′ may be additionally provided inside the electrode assembly 140 in addition to the porous sheets of the above-described embodiments. Alternatively, the porous sheet 150′ may be provided to partially replace the porous sheets of the above-described embodiments. That is, the porous sheets of the above-described embodiments may be partially or completely removed, and the porous sheet 150′ may be added inside the electrode assembly 140.

As described above, embodiments of the present disclosure may provide a secondary battery.

Some embodiments of the present disclosure may contribute to uniformly distributing the electrolyte to each region of the electrode assembly. In some embodiments, the porous sheet may be provided to temporarily accommodate the electrolyte and discharge the accommodated electrolyte as the electrode assembly expands, thereby contributing to a uniform distribution of the electrolyte in the secondary battery. In addition, in some embodiments, the diffusion guide may be provided to guide the electrolyte discharged from the porous sheet to flow to each region of the electrode assembly such as an upper region, thereby contributing to a uniform distribution of the electrolyte.

In addition, some embodiments of the present disclosure may contribute to alleviating a problem of electrolyte depletion in some regions according to the arrangement direction of the secondary battery. In some embodiments, the porous sheet and the diffusion guide may function to disperse the electrolyte concentrated in the lower region of the electrode assembly to the upper region, thereby contributing to improving electrolyte depletion in the upper region. In addition, an electrolyte imbalance between the upper and lower regions may be alleviated.

In addition, some embodiments of the present disclosure may autonomously implement the electrolyte distribution function and the like in each secondary battery. In some embodiments, the porous sheet and the diffusion guide may distribute the electrolyte through the contraction and expansion of the electrode assembly without a separate external driving source. In some embodiments, the shapes, structures, and arrangements of the proposed porous sheet and diffusion guide may contribute to more effectively implementing such electrolyte distribution.

In addition, some embodiments of the present disclosure may contribute to improving the performance and lifetime of the secondary battery through the electrolyte distribution function and the like.

Some embodiments of the present disclosure can provide a secondary battery.

In addition, some embodiments of the present disclosure can provide a secondary battery capable of more uniformly distributing an electrolyte.

In addition, some embodiments of the present disclosure can provide a secondary battery capable of alleviating electrolyte depletion according to an arrangement direction.

In addition, some embodiments of the present disclosure can provide a secondary battery capable of autonomously implementing an electrolyte distribution function.

In addition, some embodiments of the present disclosure can provide a secondary battery in which the performance or lifetime can be improved.

The above description is merely an example of applying the principles of the present disclosure, and other configurations may be further included without departing from the scope of the present disclosure.

What is claimed is:

1. A secondary battery comprising:
a case;
an electrode assembly accommodated inside the case;
a porous sheet disposed between the case and the electrode assembly and configured to temporarily accommodate an electrolyte inside the case or discharge the accommodated electrolyte; and
a diffusion guide disposed on the porous sheet and configured to guide the electrolyte discharged from the porous sheet to flow inside the case.

2. The secondary battery of claim 1, wherein the case is provided as a prismatic case having a predetermined level of rigidity.

3. The secondary battery of claim 1, wherein the electrode assembly is provided to expand and contract in a thickness direction according to charging and discharging.

4. The secondary battery of claim 1, wherein the porous sheet is provided with pores in which the electrolyte is accommodated.

5. The secondary battery of claim 1, wherein the porous sheet is elastically deformed according to expansion and contraction of the electrode assembly and is provided to be compressed and relaxed in a thickness direction.

6. The secondary battery of claim 1, wherein:
the electrode assembly includes a front surface and a rear surface spaced apart in a thickness direction; and
the porous sheet has an area corresponding to the front surface or the rear surface and is provided to be in surface contact with the front surface or the rear surface.

7. The secondary battery of claim 1, wherein:
the electrode assembly includes a front surface and a rear surface spaced apart in a thickness direction; and
the porous sheet is disposed on each of the front surface and the rear surface.

8. The secondary battery of claim 1, wherein the porous sheet is compressed between the case and the electrode assembly as the electrode assembly expands, thereby discharging the accommodated electrolyte into the case.

9. The secondary battery of claim 1, wherein the porous sheet is relaxed between the case and the electrode assembly as the electrode assembly contracts, thereby accommodating the remaining electrolyte inside the case.

10. The secondary battery of claim 1, wherein the diffusion guide is provided to guide at least a portion of the electrolyte discharged from the porous sheet to flow to an upper region of the electrode assembly.

11. The secondary battery of claim 1, wherein:
the diffusion guide includes a first guide rod provided to vertically extend on one surface of the electrode assembly; and
a plurality of first guide rods are provided to be spaced apart in a width direction on one surface of the electrode assembly.

12. The secondary battery of claim 1, wherein the diffusion guide is provided to guide at least a portion of the electrolyte discharged from the porous sheet to flow to an edge region in a width direction of the electrode assembly.

13. The secondary battery of claim 1, wherein:
the diffusion guide includes a second guide rod provided to extend in a width direction on one surface of the electrode assembly; and
a plurality of second guide rods are provided to be spaced apart in a vertical direction on one surface of the electrode assembly.

14. The secondary battery of claim 1, wherein the porous sheet has a thickness of a central region in a width direction that is smaller than a thickness of an edge region thereof.

15. The secondary battery of claim 1, wherein the diffusion guide is provided to be embedded in the porous sheet.

16. The secondary battery of claim 1, further comprising another porous sheet disposed inside the electrode assembly and configured to temporarily accommodate the electrolyte inside the electrode assembly or discharge the accommodated electrolyte.
